(19) United States
(12) Patent Application Publication
(10) Pub. No.: US 2009/0199106 A1
(43) Pub. Date: Aug. 6, 2009

(54) COMMUNICATION TERMINAL INCLUDING GRAPHICAL BOOKMARK MANAGER

(75) Inventors: Marten Andreas Jonsson, Malmo (SE); Pontus Frans Jarenskog, Malmo (SE); Martin Marcin Robert Wezowski, Malmo (SE)

Correspondence Address: MYERS BIGEL SIBLEY & SAJOVEC, P.A., P.O. BOX 37428, RALEIGH, NC, 27627, US

(73) Assignee: Sony Ericsson Mobile Communications AB

(21) Appl. No.: 12/026,148

(22) Filed: Feb. 5, 2008

(51) Int. Cl. G06F 3/00

(52) U.S. Cl. 715/744

(57) ABSTRACT

Methods of generating and displaying a list of bookmarks to remotely stored content items in a portable electronic device including a display screen include monitoring access of a content item by an application program in the portable electronic device, and storing a record including a screenshot image on the display screen associated with the content item, an address of the content item, and an identification of the application program. The methods further include displaying the screenshot image on the display screen, and in response to a selection of the screenshot image by the user, retrieving the content item from the address and invoking the application program to display the content item.

### BACKGROUND

The present invention relates to electronic devices and, more particularly, to electronic devices, methods and computer program products having internet browser capability.

Portable electronic devices, such as wireless communication terminals (e.g., cellular telephones), personal digital assistants (PDAs), palmtop computers, and the like, have the ability to access a wide range of information content, including information content stored locally and/or information content accessible over a network such as the Internet. Furthermore, many portable electronic devices include color display screens that may be used to display webpages, images and videos, among other things. Portable electronic devices may also include Internet browser software that is configured to access and display Internet content.

In many Internet browser applications, including browser applications configured for use on portable electronic devices, it is common to permit the user to store a list of favorite, or bookmarked, websites. When a user desires to access a bookmarked website, the bookmark list may be opened, and the user may scroll through the bookmark list and select a desired bookmark from the list. An entry in a bookmark list typically lists the title or URL (uniform resource locator) of the website. When a bookmark is selected, the associated website is accessed by the browser and displayed on the display screen. Similarly, history lists can be used to keep track of previously visited websites.

Managing history lists and bookmark lists can be cumbersome, however, as some websites have long titles and/or URLs that can be difficult to display and/or read on a display screen of a portable electronic device. Furthermore, it may be difficult to navigate through a list of bookmarks in a bookmark or history list to find a website of interest.

### SUMMARY

Methods of generating and displaying a list of bookmarks to internet pages according to some embodiments include monitoring access of a remotely stored internet page by an internet browser in a communication terminal, storing a thumbnail image of the internet page, storing an address associated with the internet page in response to the command, and associating the stored thumbnail image with the stored address. The thumbnail image is displayed on a display screen, and in response to a selection of the screenshot image by a user of the communication terminal, the internet page is retrieved from the address.

The methods may further include generating a list of metatags based on text in the internet page, and associating the metatags with the address and/or the thumbnail image. The methods may further include analyzing a plurality of metatags associated with stored addresses, generating at least one group category based on a frequency of occurrence of at least one of the plurality of metatags, associating a subset of the stored addresses with the at least one group category based on the association of the metatag with addresses in the subset of stored addresses, and displaying thumbnail images associated with addresses of internet pages associated with the group category.

Some embodiments provide methods of generating and displaying a list of bookmarks to content items in a portable electronic device including a display screen. The methods may include monitoring access of a content item by an application program in the portable electronic device, and storing a record including a screenshot image on the display screen associated with the content item, an address of the content item, and an identification of the application program. The methods further include displaying the screenshot image on the display screen, and in response to a selection of the screenshot image by the user, retrieving the content item from the address and invoking the application program to display the content item.

Monitoring the access of the content item by the application program may be performed by a bookmark manager application that may be separate from the application program.

The methods may further include generating a list of metatags based on text associated with the content item, and storing the metatags in the record.

The methods may further include analyzing a plurality of metatags in a plurality of stored records, generating at least one group category based on a frequency of occurrence of at least one of the plurality of metatags, and associating a subset of the stored records with the at least one group category based on the association of the at least one metatag with the subset of stored records.

The methods may further include receiving a selection of a category by a user of the portable electronic device, and displaying screenshot images on the display screen of records associated with the selected category.

The methods may further include simultaneously displaying a plurality of screenshot images associated with a plurality of records on the display screen, and in response to the selection of one of the screenshot images, retrieving the content item associated with the selected screenshot image using the address stored in the record associated with the selected screenshot image.

The record may be stored in response to a user command and/or automatically in response to access and display of the content item by the application program.

The methods may further include building a list of records including screenshot images associated with a plurality of content items, addresses of the content items, and identifications of the application programs associated with the content items, and transmitting the list of records to a remote electronic device.

The content items referenced in the records may include web pages, songs, and/or video clips.

An electronic device according to some embodiments includes a display screen, a user input device, and a controller coupled to the display and the user input device. The controller is configured to execute an application program, and a bookmark manager application. The bookmark manager application is configured to monitor access of a content item by the application program, configured to store a record including a screenshot image on the display screen associated with the content item, an address of the content item, and an identification of the application program, configured to display the screenshot image on the display screen, and configured to retrieve the content item from the address and invoke the application program to display the content item in response to a selection of the screenshot image by the user.

The bookmark manager application may be further configured to generate a list of metatags based on text associated with the content item, and configured to store the metatags in the record.

The bookmark manager application may be further configured to analyze a plurality of metatags in a plurality of stored records, configured to generate at least one group category based on a frequency of occurrence of at least one of the plurality of metatags, and configured to associate a subset of the stored records with the at least one group category based on the association of the at least one metatag with the subset of stored records.

The bookmark manager application may be further configured to receive a selection of a category by a user of the portable electronic device, and configured to display screenshot images on the display screen of records associated with the selected category.

The bookmark manager application may be further configured to simultaneously display a plurality of screenshot images associated with a plurality of records on the display screen, and configured to retrieve the content item associated with the selected screenshot image using the address stored in the record associated with the selected screenshot image in response to the selection of one of the screenshot images.

The bookmark manager application may be further configured to build a list of records including screenshot images associated with a plurality of content items, addresses of the content items, and identifications of the application programs associated with the content items, and configured to transmit the list of records to a remote electronic device.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIG. 1 is a schematic diagram of an electronic device, such as a portable electronic device, according to some embodiments and an exemplary base transceiver station.

FIG. 2 illustrates a possible relationship between a user input management unit, an operating system and application programs in an electronic device configured according to some embodiments.

FIGS. 3A to 3D illustrate a portable electronic device according to some embodiments in further detail.

FIGS. 4-7 are flowcharts illustrating operations in accordance with some embodiments.

### DETAILED DESCRIPTION OF EMBODIMENTS

The present invention now will be described more fully with reference to the accompanying drawings, in which embodiments are shown. However, this invention should not be construed as limited to the embodiments set forth herein. Rather, these embodiments are provided so that this disclosure will be thorough and complete, and will fully convey the scope of the invention to those skilled in the art. Like numbers refer to like elements throughout.

As used herein, the term “comprising” or “comprises” is open-ended, and includes one or more stated features, integers, elements, steps, components or functions but does not preclude the presence or addition of one or more other features, integers, elements, steps, components, functions or groups thereof. As used herein, the term “and/or” includes any and all combinations of one or more of the associated listed items. Furthermore, as used herein, the common abbreviation “e.g.”, which derives from the Latin phrase “exempli gratia,” may be used to introduce or specify a general example or examples of a previously mentioned item, and is not intended to be limiting of such item. If used herein, the common abbreviation “i.e.”, which derives from the Latin phrase “id est,” may be used to specify a particular item from a more general recitation.

The terminology used herein is for the purpose of describing particular embodiments only and is not intended to be limiting of the invention. As used herein, the singular forms “a”, “an” and “the” are intended to include the plural forms as well, unless the context clearly indicates otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of this disclosure and the relevant art and will not be interpreted in an idealized or overly formal sense unless expressly so defined herein.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Furthermore, “coupled” or “connected” as used herein may include wirelessly coupled or connected.

The present invention may be embodied as methods, electronic devices, and/or computer program products. Accordingly, the present invention may be embodied in hardware (e.g. a controller circuit or instruction execution system) and/or in software (including firmware, resident software, micro-code, etc.), which may be generally referred to herein as a “circuit” or “module”. Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can electronically/magnetically/optically retain the program for use by or in connection with the instruction execution system, apparatus, controller or device.

Embodiments according to the present invention are described with reference to block diagrams and/or operational illustrations of methods and communication terminals. In this regard, each block may represent a module, segment, or portion of code, which comprises one or more executable instructions for implementing the specified logical function(s). It is to be understood that each block of the block diagrams and/or operational illustrations, and combinations of blocks in the block diagrams and/or operational illustrations, can be implemented by radio frequency, analog and/or digital hardware, and/or program instructions. These program instructions may be provided to a controller, which may include one or more general purpose processors, special purpose processors, ASICs, and/or other programmable data processing apparatus, such that the instructions, which execute via the controller and/or other programmable data processing apparatus, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

These computer program instructions may also be stored in a computer-usable or computer-readable memory that may direct a computer or other programmable data processing apparatus to function in a particular manner, such that the instructions stored in the computer usable or computer-readable memory produce an article of manufacture including instructions that implement the function specified in the flowchart and/or block diagram block or blocks.

The computer-usable or computer-readable medium may be, for example but not limited to, an electronic, magnetic, optical, electromagnetic, or semiconductor system, apparatus, or device. More specific examples (a nonexhaustive list) of the computer-readable medium include the following: hard disks, optical storage devices, magnetic storage devices, a portable computer diskette, a random access memory (RAM), a read-only memory (ROM), an erasable programmable read-only memory (EPROM or Flash memory), and a compact disc read-only memory (CD-ROM).

As used herein, a “communication terminal” includes, but is not limited to, a terminal that is configured to receive/transmit communication signals via a wireline connection, such as via a public-switched telephone network (PSTN), digital subscriber line (DSL), digital cable, or another data connection/network, and/or via a wireless interface with, for example, a cellular network, a satellite network, a wireless local area network (WLAN), and/or another communication terminal.

When the communication terminal is configured to communicate over a wireless interface, it is referred to herein as a “wireless communication terminal” or a “wireless terminal.” Examples of wireless terminals include, but are not limited to, a cellular telephone, personal data assistant (PDA), pager, and/or a computer that is configured to communicate data over a wireless communication interface that can include a cellular telephone interface, a Bluetooth interface, a wireless local area network interface (e.g., 802.11), another RF communication interface, and/or an optical/infra-red communication interface.

As used herein, “mobile terminals” may be portable, transportable, installed in a vehicle (aeronautical, maritime, or land-based), or situated and/or configured to operate locally and/or in a distributed fashion at any other location(s) on earth and/or in space.

As used herein “play,” “playback,” and/or “execution” of a multimedia file is used in a general sense and may include playing an audio file over a speaker, displaying a digital image on a display screen, displaying a video file on a display screen and simultaneously playing an audio file associated with and/or embedded in the video file over a speaker, and/or displaying a web page and executing scripts associated with and/or embedded in the web page.

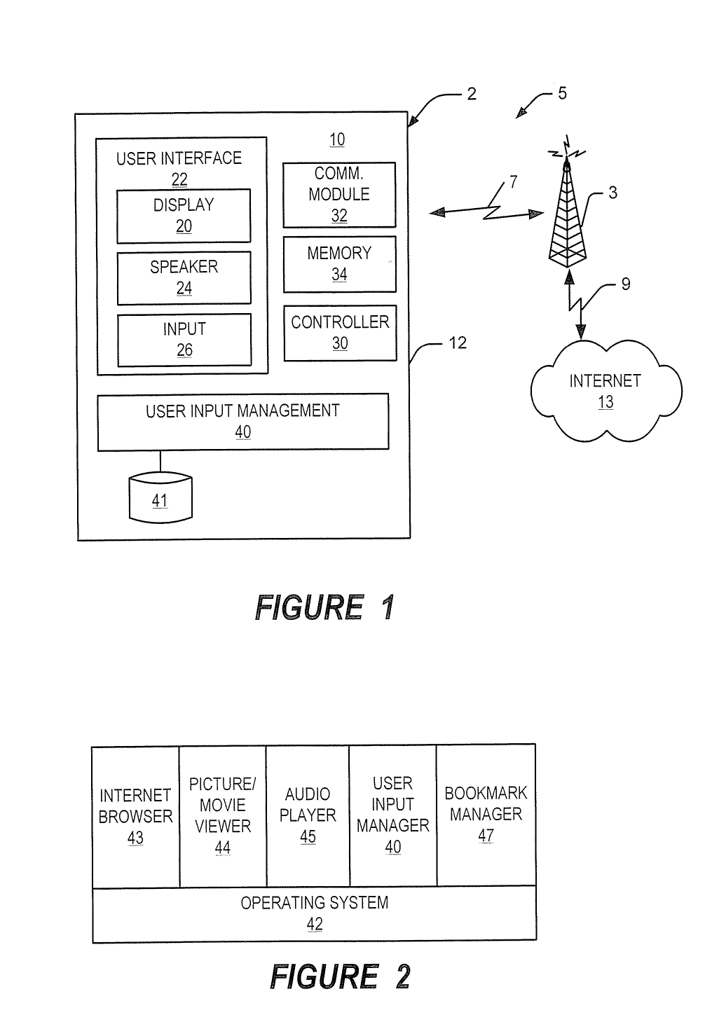

Some embodiments will now be described below with respect to FIGS. 1-7. Some embodiments provide methods and apparatus that may permit a user to rapidly locate and access stored or remote content using graphical bookmarks. Some embodiments may be particularly useful in connection with a portable electronic device having a graphical display screen.

Referring to FIG. 1, an exemplary wireless communication terminal 10 in accordance with some embodiments is illustrated. It will be appreciated that although embodiments are illustrated in connection with a wireless communication terminal, the invention may include wired mobile and/or non-mobile communication terminals and other electronic devices and methods. The wireless communication terminal 10 is configured to communicate data with one or more other wireless terminals over a direct wireless communication interface therebetween, over another wireless communication interface through one or more cellular base stations, and/or over another wireless communication interface through a wireless local area network (WLAN) router.

The wireless communication terminal 10 may be a mobile radiotelephone forming a part of a radiotelephone communication system 2 as illustrated in FIG. 1. The system 2 includes the portable electronic device 10 and a base transceiver station 3, which is part of a wireless communications network 5. In some embodiments, the base transceiver station 3 includes the radio transceiver(s) that define an individual cell in a cellular network and communicates with the portable electronic device 10 (via an interface 7) and other mobile terminals in the cell using a radio-link protocol. It will be understood that, in some embodiments, many base transceiver stations may be connected through, for example, a mobile switching center and other devices to define the wireless communications network. The base station transceiver 5 may be connected to a data communications network 13, such as the Internet, via a communication link 9. It will be appreciated that the communication link 9 may include elements of the wireless communications network and/or one or more gateways, routers, or other communication nodes.

The wireless communication terminal 10 in the illustrated embodiments includes a portable housing assembly 12, a controller circuit 30 (“controller”), a communication module 32, and a memory 34. The portable electronic device 10 further includes a user interface 22 (i.e., a man machine interface) including a display 20, a speaker 24 (i.e., a sound transducer), and at least one input device 26. The input device 26 may include a keyboard, which may be a numerical keyboard including keys that correspond to a digit as well as to one or more characters, such as may be found in a conventional wireless telephone. In some embodiments, the input device 26 may include a full QWERTY keyboard that may be operated, for example, using thumbs. More than one input device 26 may be included.

According to some embodiments, the wireless communication terminal 10 further includes a user input manager 40. The user input manager 40 may be configured to receive and process inputs received through the input device 26 of the user interface 22. In processing the user input, the user input manager 40 may refer to information stored in a database 41 (e.g. a table, file, or other associative repository). The information stored in the database 41 may include one or more lists of content identifiers associated with one or more content types and/or one or more application programs. For example, the database 41 may include a list of URL's (uniform resource locators) of favorite web pages that have been pre-stored by a user. A list of content identifiers that has been stored by the user is referred to herein as a “bookmark” list or a “favorites” list.

The database 41 may further include a list of content identifiers associated with content that a user has recently accessed, such as a history list or a list of recently used files. In some embodiments, the database 41 may include separate bookmark and history lists for each application and/or for each type of content. For example, the database 41 may include separate bookmark/history lists for web pages, audio files, image files, etc., and/or the database may include separate bookmark/history lists for different application programs installed on the portable electronic device 10. For example, there may be a separate bookmark list for an internet browser, a separate bookmark list for an image viewer, etc. In some embodiments, the database 41 may include a master bookmark list and/or a master history list that include content identifiers for different kinds of content that may be accessed using different application programs.

As used herein, the term “content identifier” may include a URL, a file name, an address, an alias, or any other identifier that uniquely identifies an item of content, such as a web page, an audio file, an image file, a document, or the like. A content identifier also includes at least one local and/or remote path or network address, such as a URL, that identifies a location for accessing the item of content. It will be appreciated that the database 41 may be stored in a memory such as the memory 34, which may be a volatile or non-volatile memory, and/or in a magnetic storage device, such as a disk drive that is accessible by the user input manager 40.

The display 20 may be any suitable display screen assembly. For example, the display screen 20 may be a liquid crystal display (LCD) with or without auxiliary lighting (e.g., a lighting panel). In some cases the wireless communication terminal 10 may be capable of playing video content of a particular quality. For example, a wireless communication terminal 10 may be configured to display a video stream having a particular aspect ratio, such as 16:9 or 4:3. A number of standard video formats have been proposed for mobile terminals, including Quarter VGA (QVGA, 320×240 pixels), Common Intermediate Format (CIF, 360×288 pixels) and Quarter Common Intermediate Format (QCIF, 180×144 pixels). Moreover, some mobile terminals may have multiple display screens having different display capabilities. Thus, a wireless communication terminal 10 may be capable of displaying video in one or more different display formats.

The user interface 22 may include any suitable input device(s) including, for example, a touch activated or touch sensitive device (e.g., a touch screen), a joystick, a keyboard/keypad, a dial, a directional key or keys, and/or a pointing device (such as a mouse, trackball, touch pad, etc.). The speaker 24 generates sound responsive to an input audio signal. The user interface 22 can also include a microphone coupled to an audio processor that is configured to generate an audio data stream responsive to sound incident on the microphone.

The controller 30 may support various functions of the wireless communication terminal 10. The controller 30 can be any commercially available or custom microprocessor, for example. In use, the controller 30 of the wireless communication terminal 10 may generate a display image on the display 20. In some embodiments, however, a separate signal processor and/or video chip (not shown) may be provided in the wireless communication terminal 10 and may be configured to generate a display image on the display 20.

The memory 34 is configured to store digital information signals and data such as a digital multimedia files (e.g., digital audio, image and/or video files).

The communication module 32 is configured to communicate data over one or more wireless interfaces to another remote wireless terminal as discussed herein. The communication module 32 can include a cellular communication module, a direct point-to-point connection module, and/or a WLAN module.

With a cellular communication module, the wireless communication terminal 10 can communicate via the base transceiver station(s) 3 of the network 5 using one or more cellular communication protocols such as, for example, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and Universal Mobile Telecommunications System (UMTS). The cellular base stations may be connected to a Mobile Telephone Switching Office (MTSO) wireless network, which, in turn, can be connected to a PSTN and/or another network.

A direct point-to-point connection module may include a direct RF communication module or a direct IR communication module. The direct RF communication module may include a Bluetooth module. With a Bluetooth module, the wireless communication terminal 10 can communicate via an ad-hoc network through a direct point-to-point interface.

With a WLAN module, the wireless communication terminal 10 can communicate through a WLAN using a communication protocol that may include, but is not limited to, 802.11a, 802.11b, 802.11e, 802.11g, and/or 802.11i.

The communication module 32 can include a transceiver typically having a transmitter circuit and a receiver circuit, which respectively transmit outgoing radio frequency signals (e.g., to the network 5, a router or directly to another terminal) and receive incoming radio frequency signals (e.g., from the network 5, a router or directly to another terminal), such as voice and data signals, via an antenna. The communication module 32 may include a short range transmitter and receiver, such as a Bluetooth transmitter and receiver.

The wireless communication terminal 10 may also be configured to communicate electronically with another terminal via a wireline or cable for the transmission of digital communication signals therebetween. The wireless communication terminal 10 may include further components such as a camera device configured to generate a still image and/or video data stream based on incident light.

Although FIG. 1 illustrates an exemplary hardware/software architecture that may be used in mobile terminals and/or other electronic devices for management and playback of multimedia files, it will be understood that the present invention is not limited to such a configuration but is intended to encompass any configuration capable of carrying out operations described herein. For example, although the memory 34 is illustrated as separate from the controller 30, the memory 34 or portions thereof may be considered as a part of the controller 30. More generally, while particular functionalities are shown in particular blocks by way of illustration, functionalities of different blocks and/or portions thereof may be combined, divided, and/or eliminated. Moreover, the functionality of the hardware/software architecture of FIG. 1 may be implemented as a single processor system or a multi-processor system in accordance with various embodiments.

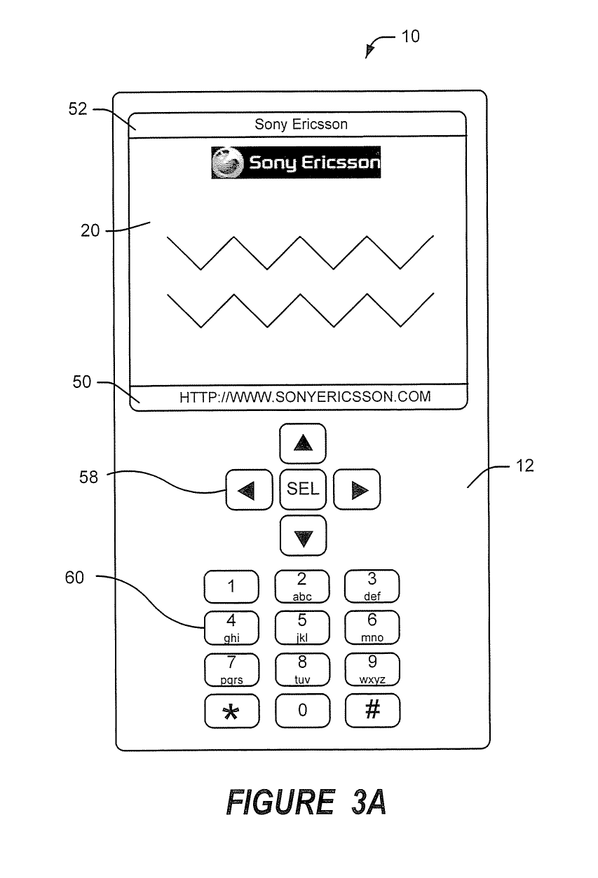

As shown in FIG. 2, the user input manager 40 may be implemented as a software module that runs on an operating system 42 of the wireless communication terminal 10 separately from application software such as an internet browser 43, a picture/movie viewer 44, and/or an audio player 45. Thus, in some embodiments, the user input manager 40 may process user input from the input device 26 for more than one application program running in the wireless communication terminal 10. The user input manager 40 may be configured to determine which application program is active when user input is received, and to associate the user input with an appropriate list of stored content identifiers, such as items in a bookmark list and/or items in a history list, depending on which application program is currently active.

In other embodiments, each application program may be configured to invoke a separate instance of the user input manager 40, which then processes user input exclusively for the invoking application.

The wireless communication terminal device 10 may also include a bookmark manager module 47 that manages bookmarks, i.e. stored lists of content identifiers that reference accessible content items. The bookmark manager 47 can manage stored lists of content identifiers on its own and/or on behalf of other applications, such as the internet browser 43, the picture viewer 44, the audio player 45, etc. Although the bookmark manager 47 is illustrated as a separate module in FIG. 2, it may be implemented within another application module, such as within the internet browser 43.

The bookmark manager 47 may be invoked by an application, such as the internet browser 43. In some embodiments, the bookmark manager 47 can be invoked by a user as a separate application.

When an application program, such as the internet browser 43, invokes the bookmark manager 47, the application program may provide the bookmark manager 47 with operating parameters, such as a pointer to a bookmark list (i.e. a list of content identifiers that have been stored by the user) and/or a history list or other list of automatically stored content identifiers such as a recently used files list associated with an application program.

Alternatively or additionally, the bookmark manager 47 can maintain separate bookmark lists, which can include references to various types of content that are processed by different application programs. For example, the bookmark manager 47 can maintain a bookmark list that contains references not only to websites, but also to video clips, songs, pictures, etc.

In some embodiments, the bookmark manager 47 can operate as a background application to monitor activity of other application programs and build bookmark lists including content accessed by application programs. For example, the bookmark manager 47 can monitor activity by an internet browser 43 and a picture/movie viewer 44, and can build bookmark/history lists including entries corresponding to websites accessed by the internet browser 43 and pictures/movies displayed by the picture/movie viewer 44.

The bookmark manager 47 may refer to the content identifiers in the manner described below in order to enable the user to rapidly select an item of content for display/execution by an application program.

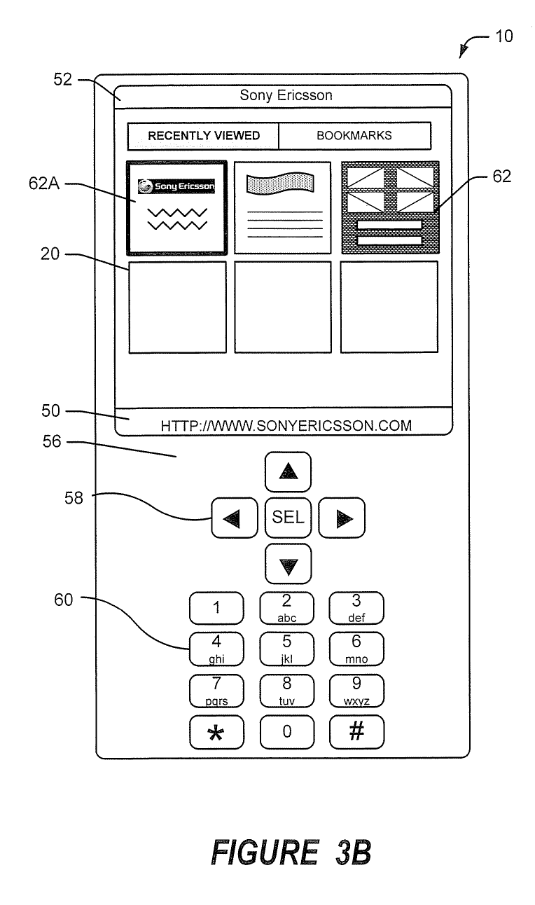

Referring to FIGS. 3A to 3D, a wireless communication terminal 10 is shown in more detail. The wireless communication terminal 10 includes a housing 12 on which a display 20 is provided. Also provided on the housing 12 are an alphanumeric keypad 60 and a set of selection keys 58 including up (▴), down (▾), and select (SEL) keys.

The alphanumeric keypad 60 may include a standard 10 digit numeric keypad in which the keys 2-9 are also used for alpha input. (For example, when the key ‘2’ is pressed repeatedly, the input may cycle sequentially through 2, a, b, and c). However, it will be appreciated that the alphanumeric keypad 60 could include a full QWERTY keyboard, a touchpad with character recognition, or other input device. Moreover, the selection keys 58 could be replaced by many different input devices, such as a pointing stick, a touchpad, jogdial, etc.

Referring to FIGS. 2 and 3A, the wireless communication terminal 10 may include an browser module 43 that is capable of retrieving, formatting and displaying on the display 20 HTML-formatted webpages as well as other types of content that can be accessed though a data communications network, such as the Internet. When a webpage is displayed on the display 20, an address bar 50 on the display 20 may display the URL (i.e. internet address) of the webpage that is currently being displayed (e.g. http://www.sonyericsson.com), while a title bar 52 may display a name of the webpage currently being displayed.

As noted above, the bookmark manager 47 monitors the content accessed by application programs. When an item of content, such as a webpage, picture, movie, etc., is accessed by an application program, such as the internet browser 43, the bookmark manager 47 can automatically save a screenshot image of the webpage/picture/movie that is displayed on the screen 20. The size of the screenshot image can be reduced and/or compressed by the bookmark manager 47 and stored as, for example, a thumbnail image. The bookmark manager 47 also stores a location identifier associated with the item of content, such as a URL and/or file path associated with the content item. The bookmark manager 47 can also store a name of the item of content and an identifier of the application used to access the content item. The bookmark manager 47 then associates the stored thumbnail image with the location identifier, the name of the content item, and/or the name of the application program for later use.

For example, when the internet browser 43 accesses a web page (e.g. www.sonyericsson.com) via the internet, the bookmark manager 47 may automatically store a screenshot image of the webpage in a reduced format, e.g., a thumbnail image. The bookmark manager 47 can also store the URL of the website (http://www.sonyericsson.com) as well as the name of the website (Sony Ericsson), and associate the stored URL and name with the stored thumbnail image. For example, the bookmark manager 47 can create a record in a database including the thumbnail image, the URL and the name of the web page. The record can also include a date/time stamp indicating when the content item was accessed, and may also store data identifying the application that was used to access the item of content.

In some embodiments, the bookmark manager 47 can analyze text data stored in the item of content, or data stored along with the item of content, such as metadata, to build metatags that can be associated with the item of content. For example, the bookmark manager can store as metatags all words appearing in the URL or title of the content item, all words associated with the content item as metadata, and/or one or more words appearing in the content item itself, as metatags.

Many different algorithms can be used to determine which words from the content item itself should be stored as metatags. For example, for a web page, the bookmark manager 47 could store as metatags the nouns and/or verbs that appear most frequently in the web page.

The bookmark manager 47 can then place the item of content into one or more predetermined categories based on the metatags that are stored for the item. Similarly, the bookmark manager can analyze text data from one or more content items to identify categories within which the items can be placed. For example, if the phrase “football” appears as a metatag in a predetermined number or percentage of records, the bookmark manager 47 can create a category “football” for content associated with football.

In some embodiments, the bookmark manager 47 may store bookmark records automatically whenever a new content item is accessed. In other embodiments, the bookmark manager 47 may store bookmark records only in response to a user command.

A user of the wireless communication terminal 10 can use the bookmark manager 47 to navigate quickly and visually through stored bookmark lists and/or history lists. For example, referring to FIG. 3B, in response to a user command, the bookmark manager 47 can display a visual tree of thumbnail images 62 from stored bookmark records associated with previously accessed content items. A selected thumbnail image 62A can be highlighted, for example with a different and/or larger border. Alternatively or additionally, the selected thumbnail image 62A could be displayed in color, while the non-selected thumbnail images could be displayed in grayscale.

The thumbnail images 62 can be displayed in many different formats. For example, as shown in FIG. 3B, the thumbnail images 62 can be displayed as tiles. Other graphical display metaphors are possible. For example, as shown in FIG. 3C, the thumbnail images could be layered on top of one another, as if in one or more stacks. As illustrated in FIG. 3D, the thumbnail images 62 could be displayed as though they were cards on a Rolodex that the user can visually flip through by scrolling in one direction or another with the directional keys 58.

The thumbnail images 62 can be organized in many different ways. For example, they can be presented in chronological order according to their most recent date/time of access, in categories according to the metatags associated with the records, in alphabetical order, or in any other desired order. The order/organization of the thumbnail images 62 can be selected by the user via a command/menu selection or the like.

The bookmark manager 47 can display only those thumbnails corresponding to a particular category/metatag. For example, the bookmark manager 47 can allow the user to scroll through a list of available categories/metatags pulled from bookmark records stored in the bookmark list. When the user selects one or more of the categories/metatags, the bookmark manager 47 can display thumbnails from only those recoreds corresponding to the selected categories/metatags. Similarly, the bookmark manager 47 can be configured to let the user limit the scope of thumbnail images displayed by specifying one or more “stop” tags. That is, if the user specifies a “stop” metatag, the bookmark manager will suppress the display of thumbails corresponding to records associated with the “stop” metatag.

According to some embodiments, a bookmark list including a set of bookmark records generated by the bookmark manager 47 can be transmitted to a remote party, such as another wireless communication terminal 10 through a network, such as the wireless communication network 5 shown in FIG. 1. Thus, for example, a user can easily share a list of favorite websites or other content items with a friend. Furthermore, the recipient of the bookmark list can easily view and select content items to view using the graphical bookmark display provided herein.

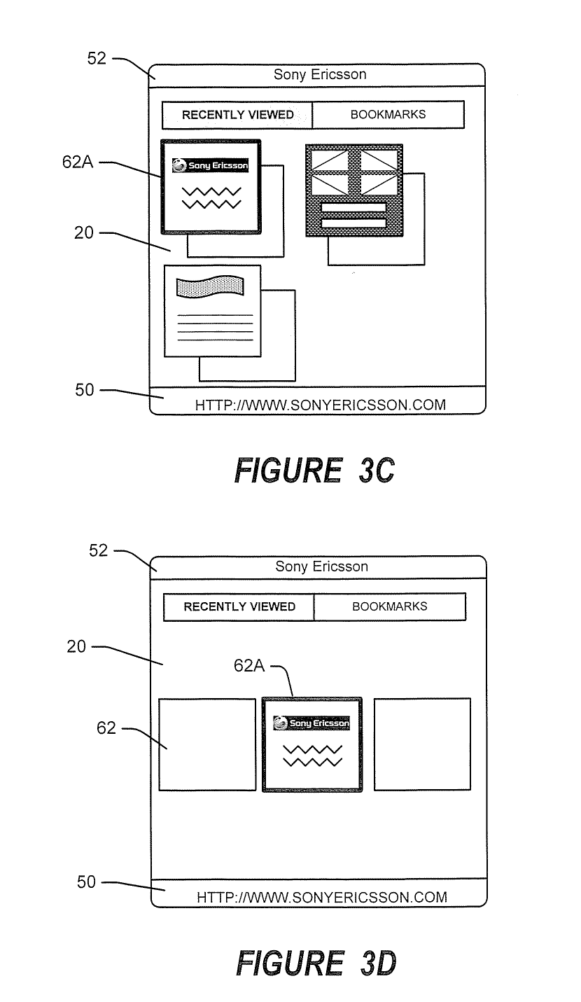

FIGS. 4-7 are flowcharts illustrating operations in accordance with some embodiments. For example, operations of a device according to some embodiments are illustrated in FIG. 4. As shown therein, a content item, such as a web page, picture, video, etc., is accessed by an application program (Block 70). In response, the bookmark manager 47 stores a screenshot image associated with the content item in a record, along with the name of the application program that accessed the content item, and an address of the content item (Block 72).

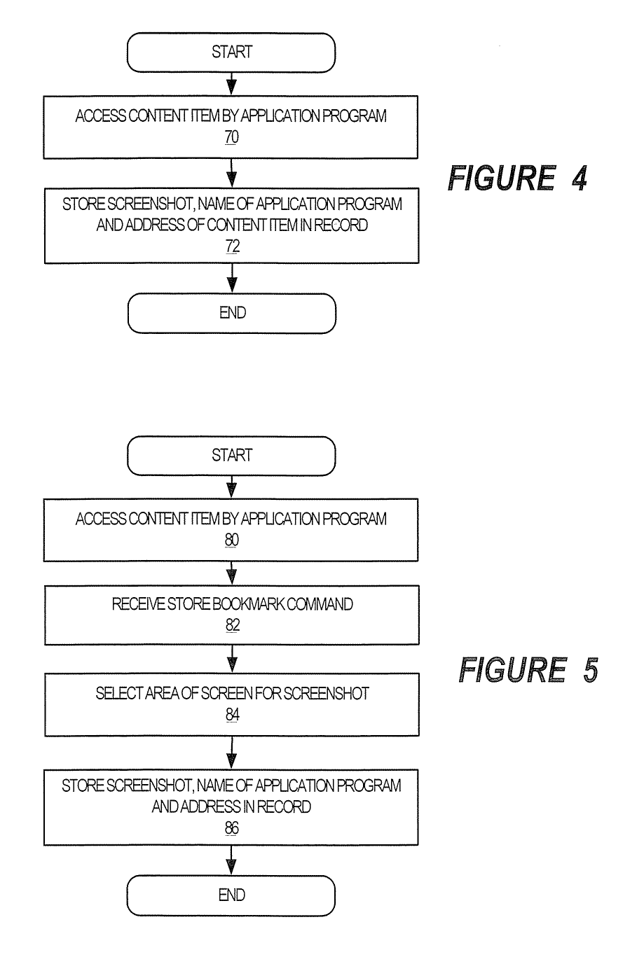

Referring to FIG. 5, additional embodiments are illustrated. In the embodiments of FIG. 5, after the content item is accessed (Block 80), a command is received by the bookmark manager 47 instructing the bookmark manager 47 to store a bookmark associated with the accessed content item (Block 82). The bookmark manager 47 may then select an area of the display screen 20 for the screenshot. For example, the bookmark manager 47 may select an area of the screen 20 associated with the application program that accessed the content item (Block 84). The bookmark manager then stores a screenshot image associated with the content item in a record, along with the name of the application program that accessed the content item, and an address of the content item (Block 86).

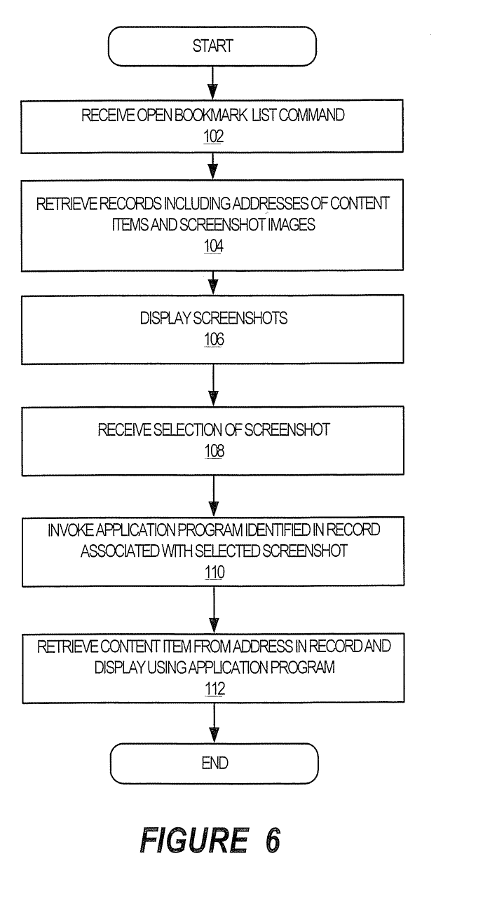

Further embodiments are illustrated in FIG. 6. As shown therein, a command to open a bookmark list is received by the bookmark manager 47 (Block 102). In response, the bookmark manager 47 retrieves records from a stored bookmark list including addresses of content items and associated screenshot images (Block 104). The records may also include names of the content items and/or identifications of application programs used to display the content items. The bookmark manager 47 then displays the screenshot images 62 on the display screen 20 (Block 106). For example, the bookmark manager 47 may display multiple screenshot images on the display screen 20. Using a user input device 26, the user can then select one of the screenshot images (Block 108) corresponding to a content item the user would like to display. In response to the user's selection, the bookmark manager 47 invokes the application program identified in the record associated with the screenshot (Block 110). The bookmark manager 47 and/or the application program can then retrieve the content item from the address in the record, and the application program can display the content item (Block 112).

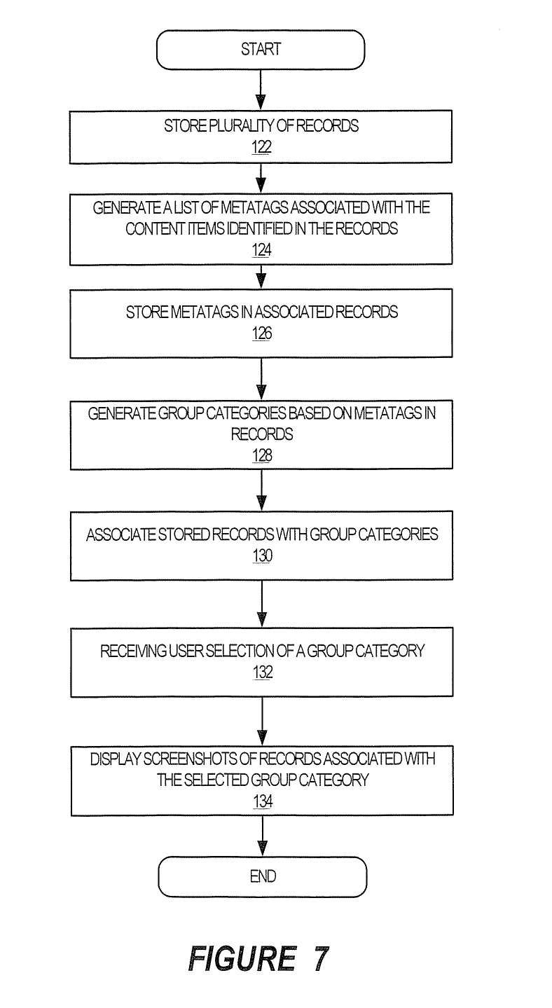

Further embodiments are illustrated in FIG. 7. As shown therein, a bookmark manager 47 can store a plurality of bookmark records including screenshots, addresses and names (Block 122). The bookmark records can be stored automatically, such as when items of content are accessed and/or can be stored in response to user commands.

When the content items are accessed, the bookmark manager can generate a list of metatags associated with the content items (Block 124). For example, the bookmark manager can generate the list of metatags from text data in the content item or associated with the content item. The metatags are stored in the associated records (Block 126).

The bookmark manager can then generate group categories based on metatags in the records of a particular bookmark list. For example, by analyzing the metatags, the bookmark manager can identify groups into which the records can be organized (Block 128). In some embodiments, the groups may be specified by a user. The bookmark manager 47 can then associate the stored records with group categories (Block 130).

A user can select a particular group category (Block 132), and in response, the bookmark manager 47 can display screenshots of records associated with the selected group category (Block 134). The user can then select one of the screenshot images corresponding to a content item the user would like to display. In response to the user's selection, the bookmark manager 47 invokes the application program identified in the record associated with the screenshot. The bookmark manager 47 and/or the application program can then retrieve the content item from the address in the record, and the application program can display the content item.

While embodiments have been described in connection with a mobile telephone, embodiments of the invention can be implemented in many different type of devices, including portable electronic devices, such as personal digital assistants (PDAs), laptop computers, and the like, as well as non-portable devices such as desktop computers.

In the drawings and specification, there have been disclosed typical embodiments and, although specific terms are employed, they are used in a generic and descriptive sense only and not for purposes of limitation, the scope of the invention being set forth in the following claims.

That which is claimed is:

1. A method of generating and displaying a list of bookmarks to internet pages, comprising:
monitoring access of a remotely stored internet page by an internet browser in a communication terminal;
storing a thumbnail image of the internet page;
storing an address associated with the internet page in response to the command;
associating the stored thumbnail image with the stored address;
displaying the thumbnail image on a display screen; and
in response to a selection of the screenshot image by a user of the communication terminal, retrieving the internet page from the address.

2. The method of claim 1, further comprising:
generating a list of metatags based on text in the internet page, and associating the metatags with the address and/or the thumbnail image.

3. The method of claim 2, further comprising:
analyzing a plurality of metatags associated with stored addresses;
generating at least one group category based on a frequency of occurrence of at least one of the plurality of metatags;
associating a subset of the stored addresses with the at least one group category based on the association of the metatag with addresses in the subset of stored addresses; and
displaying thumbnail images associated with addresses of internet pages associated with the group category.

4. A method of generating and displaying a list of bookmarks to content items in a communication terminal including a display screen, the method comprising:
monitoring access of a remote content item by an application program in the portable electronic device;
storing a record including a screenshot image on the display screen associated with the content item, an address of the content item, and an identification of the application program;
displaying the screenshot image on the display screen; and
in response to a selection of the screenshot image by the user, retrieving the content item from the address and invoking the application program to display the content item.

5. The method of claim 4, wherein monitoring the access of the content item by the application program is performed by a bookmark manager application that is separate from the application program.

6. The method of claim 4, further comprising:
generating a list of metatags based on text associated with the content item; and
storing the metatags in the record.

7. The method of claim 6, further comprising:
analyzing a plurality of metatags in a plurality of stored records;
generating at least one group category based on a frequency of occurrence of at least one of the plurality of metatags; and
associating a subset of the stored records with the at least one group category based on the association of the at least one metatag with the subset of stored records.

8. The method of claim 7, further comprising:
receiving a selection of a category by a user of the portable electronic device; and
displaying screenshot images on the display screen of records associated with the selected category.

9. The method of claim 4, further comprising:
simultaneously displaying a plurality of screenshot images associated with a plurality of records on the display screen; and
in response to the selection of one of the screenshot images, retrieving the content item associated with the selected screenshot image using the address stored in the record associated with the selected screenshot image.

10. The method of claim 4, wherein the record is stored in response to a user command.

11. The method of claim 4, wherein the record is stored automatically in response to access and display of the content item by the application program.

12. The method of claim 4, further comprising building a list of records including screenshot images associated with a plurality of content items, addresses of the content items, and identifications of the application programs associated with the content items; and
transmitting the list of records to a remote electronic device.

13. The method of claim 12, wherein the content items referenced in the records include web pages, songs, and/or video clips.

14. A communication terminal comprising:
a display screen;
a user input device;
a controller that is coupled to the display and the user input device, and that is configured to execute an application program; and
a bookmark manager application that is configured to monitor access of a remotely stored content item by the application program, configured to store a record including a screenshot image on the display screen associated with the content item, an address of the content item, and an identification of the application program, configured to display the screenshot image on the display screen, and configured to retrieve the content item from the address and invoke the application program to display the content item in response to a selection of the screenshot image by the user.

15. The communication terminal of claim 14, wherein the bookmark manager application is separate from the application program.

16. The communication terminal of claim 14, wherein the bookmark manager application is further configured to generate a list of metatags based on text associated with the content item, and configured to store the metatags in the record.

17. The communication terminal of claim 16, wherein the bookmark manager application is further configured to analyze a plurality of metatags in a plurality of stored records, configured to generate at least one group category based on a frequency of occurrence of at least one of the plurality of metatags, and configured to associate a subset of the stored records with the at least one group category based on the association of the at least one metatag with the subset of stored records.

18. The communication terminal of claim 17, wherein the bookmark manager application is further configured to receive a selection of a category by a user of the portable electronic device, and configured to display screenshot images on the display screen of records associated with the selected category.

19. The communication terminal of claim 14, wherein the bookmark manager application is further configured to simultaneously display a plurality of screenshot images associated with a plurality of records on the display screen, and configured to retrieve the content item associated with the selected screenshot image using the address stored in the record associated with the selected screenshot image in response to the selection of one of the screenshot images.

20. The communication terminal of claim 14, wherein the bookmark manager application is further configured to build a list of records including screenshot images associated with a plurality of content items, addresses of the content items, and identifications of the application programs associated with the content items, and configured to transmit the list of records to a remote electronic device.
